(19) United States
(12) Patent Application Publication
(10) Pub. No.: US 2018/0342761 A1
(43) Pub. Date: Nov. 29, 2018

(54) Low-Aspect-Ratio Battery Cells

(71) Applicant: Pellion Technologies, Woburn, MA (US)

(72) Inventors: David Eaglesham, Lexington, MA (US); Christopher Fischer, Concord, MA (US); Robert Ellis Doe, Medfield, MA (US)

(73) Assignee: Pellion Technologies, Woburn, MA (US)

(21) Appl. No.: 15/988,085

(22) Filed: May 24, 2018

Related U.S. Application Data
(60) Provisional application No. 62/510,389, filed on May 24, 2017.

(51) Int. Cl. H01M 10/0525; H01M 10/44; H01M 10/056; H01M 10/04

(52) U.S. Cl. CPC H01M 10/0525; H01M 10/44; H01M 10/0459; H01M 10/0431; H01M 10/056

(57) ABSTRACT

An electrochemical cell includes an electrode assembly comprising at least one pair of a wound or stacked anode and cathode a housing comprising an insulating soft flexible pouch enclosing the electrode assembly. The electrode assembly and each anode and cathode respectfully have a thickness, width and length measured parallel to a common set of orthogonal axes, wherein (i) the thickness represents the smallest dimension of each anode and cathode but represents the greatest dimension of the full electrode assembly, (ii) the width represents a maximum dimension perpendicular to the thickness, and (iii) an aspect ratio of the width to the thickness of the electrode assembly is less than 1.

### RELATED APPLICATION

This application claims the benefit of U.S. Provisional Application No. 62/510,389, filed 24 May 2017, the entire content of which is incorporated herein by reference.

### BACKGROUND

Rechargeable or secondary cells and batteries comprising a plurality of cells, have wide-ranging applications that require persistent improvement of battery performance. A common problem in the design of battery packs lies in the mechanical design of the pack itself. This is caused by the fact that the battery needs to accommodate the dimensional changes of the battery over the course of its lifetime. These may be caused by the gradual increase in the dimensions of the battery as it ages (“swelling”) or by the cyclic changes in the dimensions of the battery over the course of each cycle (“breathing”). In Pb-acid batteries, for example, the primary dimensional change is typically swelling caused by the gradual accumulation of Pb sulfates as a side-reaction in the cell.

Li-ion cells generally contain active materials that operate on the principle of intercalation wherein Li+ ions migrate in and out of host structures (e.g., graphitic negative electrodes and layered transition metal oxide positive electrode materials) in a reversible fashion without inducing large structural changes to the host material. In the case of Li-ion cells where intercalation reactions occur on both electrodes, there is relatively little dimensional change (typically <0.5% volume swing) during cycling (breathing) as the partial molar volume of Li is near zero at both electrodes. Furthermore, irreversible expansion (swelling) is typically limited by the slow growth of the solid electrolyte interphase (SEI) layer. Fundamentally, these limited dimensional changes during cycling provide a high degree of reversibility for the electrochemical reactions in the cell; however, it also limits the energy density of the electrode stack and, therefore, the cell.

It is widely accepted that significant improvement in energy density could be obtained by migration away from pure intercalation host reactions to electrode reactions involving fundamentally different physical processes during operation as the latter reactions allow for denser storage of Li-ions compared to intercalation. Among these reactions are conversion, or displacement reactions, alloying reactions, and metal deposition. However, these reaction types are typically associated with relatively large structural change (e.g., ≥5% volume expansion) within the electrode materials and, therefore, of the battery cell. That is, the cell is sometimes said to “breathe”, as a characterization of the physical expansion and contraction during charge and discharge. Fundamentally, a high degree of repeated volume expansion and contraction due to the electrochemical reaction in the cell will coincide with a higher proportion of mechanical degradation of the cell assembly (e.g., electrode stack, cell and battery package fatigue) resulting in deterioration of the cell, cycle life, power density, and margin for safe operation thus offsetting gains in energy density.

Li-ion battery form factors include cylinders (e.g., 18650 or AA type), button cell (watch type), and prismatic (cell phone type). Commercial cylindrical Li-ion rechargeable cells (batteries) typically have an aspect ratio, a>1, where a=w/t, wherein the width, w, is the largest dimension parallel to electrode layers (i.e., parallel to the greatest orthogonal dimensions of the electrode layers), and wherein t is the largest dimension perpendicular to the electrode layers. A well-known reason for the choice of this high aspect ratio is that an “end” of the cylinder in a wound cell is overhead (i.e., structure or volume in the cell that does not contribute to the battery's storage capacity). To prevent failures due to cell shorting, there advantageously is overlap of the insulator and one of the electrodes at each end of the cell. This overlap region has a finite minimum dimension, which adds to overall cell size, but contributes no capacity. The last layer in a cell stack (i.e., the outer cylindrical wall of a wound cell) also contributes overhead, but the minimum dimension is smaller. Cylindrical wound cells also typically have safety devices at the top, which further increase overhead. Thus to minimize overall cell overhead, a cylindrical cell advantageously has a minimum amount of volume for additional structures at the “end” for a given volume.

U.S. Patent Publication No. 2012/0100406 to Gaugler discloses fitting a wound Li-ion cell into a Li-metal button form factor (i.e., a hard metal case) with connectors welded to the casing. U.S. Pat. No. 8,728,651 to Brilmyer discloses a spiral-wound valve-regulated lead-acid (“VRLA”) battery having an aspect ratio <1. The disclosed structure includes a lead-acid chemistry with an aqueous electrolyte and a hard polymer or metal case.

Referring to FIG. 1, stacked cells similarly typically have an aspect ratio >1 [i.e., the thickness of the electrode assembly stack (measured vertically in the orientation shown and also aligned with the external cell dimension “thickness”) is less than the minimum length or width dimension of the stack (measured orthogonally to the thickness of any single layer in the stack). In a stacked cell, similarly to cylindrical cells, the edges of the layers introduce higher overhead than the top—again because the successive positive and negative layers have an insulator that is typically offset to prevent them from shorting to each other. The sealing/insulating layers at the top/bottom of the stack introduce overhead but a smaller amount; so again, it is well-known to cell designers that it is advantageous for a stacked cell to have a width and length greater than its thickness.

“Wound prismatic” cells have elements of both structures (wound cells being cheaper to manufacture, but having the flat form factor preferred in many applications). Again, commercially available cells have a maximum dimension perpendicular to the layers (i.e., thickness, t, which is measured vertically in FIG. 1, and which is perpendicular to the greatest dimensions of the layers, referred to as the length, l, and width, w, of the layers) that is smaller than a maximum dimension parallel to the layers.

### SUMMARY

Low aspect ratio battery cells, and methods involving the cells, are described herein, where various embodiments of the apparatus and methods may include some or all of the elements, features and steps described below.

Embodiments of the apparatus relate to stacked or spiral-wound battery cells, such as high-energy non-aqueous cells, with an aspect ratio (a) less than 1.

An electrochemical cell of this disclosure includes an electrode assembly comprising at least one pair of a wound or stacked anode and cathode a housing comprising an insulating soft flexible pouch enclosing the electrode assembly. The electrode assembly and each anode and cathode respectfully have a thickness, width and length measured parallel to a common set of orthogonal axes, wherein (i) the thickness represents the smallest dimension of each anode and cathode but represents the greatest dimension of the full electrode assembly, (ii) the width represents a maximum dimension perpendicular to the thickness, and (iii) an aspect ratio of the width to the thickness of the electrode assembly is less than 1.

The housing can include an insulating soft flexible pouch capable of accommodating >5% breathing of the enclosed the electrode assembly.

### BRIEF DESCRIPTION OF DRAWINGS

FIG. 1 is a sketch of a conventional laminate cell construction comprising cathodes 12, separators 14, and an anode 16.

FIGS. 2 and 3 provide a schematic illustration showing a cell 10 before (FIG. 2) and after (FIG. 3) swelling and stack-pressure forces are exerted in a cell 10 with a planar configuration. Swelling (expansion of the stack 24) involves curvature of the electrodes and/or case 22. Forces exerting stack pressure are thus limited by the yield-point strength of the electrodes or of the case 22 in a beam-bending configuration.

FIGS. 4 and 5 provide a schematic illustration showing swelling and stack-pressure forces in a cell 10 of this disclosure. Swelling (expansion of the stack 24) now involves extension of the electrodes 12 and 16 or case 22. Forces exerting stack pressure are now limited by the yield-point strength of the electrodes 12/16 or of the case 22 in uniaxial extension.

FIG. 6 is a schematic illustration of stacked electrodes 12 and 16 with a soft pouch 26 shown without tabs.

FIG. 7 are schematic illustrations of stacked electrodes with a soft pouch 26 shown with tabs 18 and 20.

FIGS. 8 and 9 are photographic images of stacked cells in soft pouches 26.

FIG. 10 shows a cell embodiment, wherein the housing includes conductive plates 30 and 32 integrated with the pouch 26.

FIG. 11 illustrates a “racetrack” arrangement of layers in a “wound prismatic” cell 10.

FIG. 12 is a top view of a prismatic wound cell showing excess area due to seal.

FIG. 13 shows a top view of a button cell (wound cell) showing excess area 34 due to seal 28.

FIG. 14 shows a “no-seam” implementation with the top contact exposed for “button cell” replacement with reduced dead area.

FIG. 15 shows a “no-seam” implementation with the bottom contact exposed for “button cell” replacement with reduced dead area.

In the accompanying drawings, like reference characters refer to the same or similar parts throughout the different views; and apostrophes are used to differentiate multiple instances of the same item or different embodiments of items sharing the same reference numeral. The drawings are not necessarily to scale; instead, an emphasis is placed upon illustrating particular principles in the exemplifications discussed below. For any drawings that include text (words, reference characters, and/or numbers), alternative versions of the drawings without the text are to be understood as being part of this disclosure; and formal replacement drawings without such text may be substituted therefor.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

In various embodiments, a battery cell design has a low-aspect ratio cell disposed in a soft, non-conducting pouch cell package. The battery cell can have a cross-section that is square, circular, or of another shape. The stack of electrodes is thicker than it is wide, and is disposed in a flexible pouch format, rather than a hard can, so as to accommodate >5% reversible expansion and contraction during electrochemical cycling. The use of a soft flexible pouch (e.g., that is more than an order of magnitude more compliant than the electrode assembly) in combination with a low-aspect-ratio battery cell can provide various advantages, including accommodation of breathing and swelling of the stack with charge and discharge, greater flexibility of form-factor, simpler cell assembly, and lower component cost.

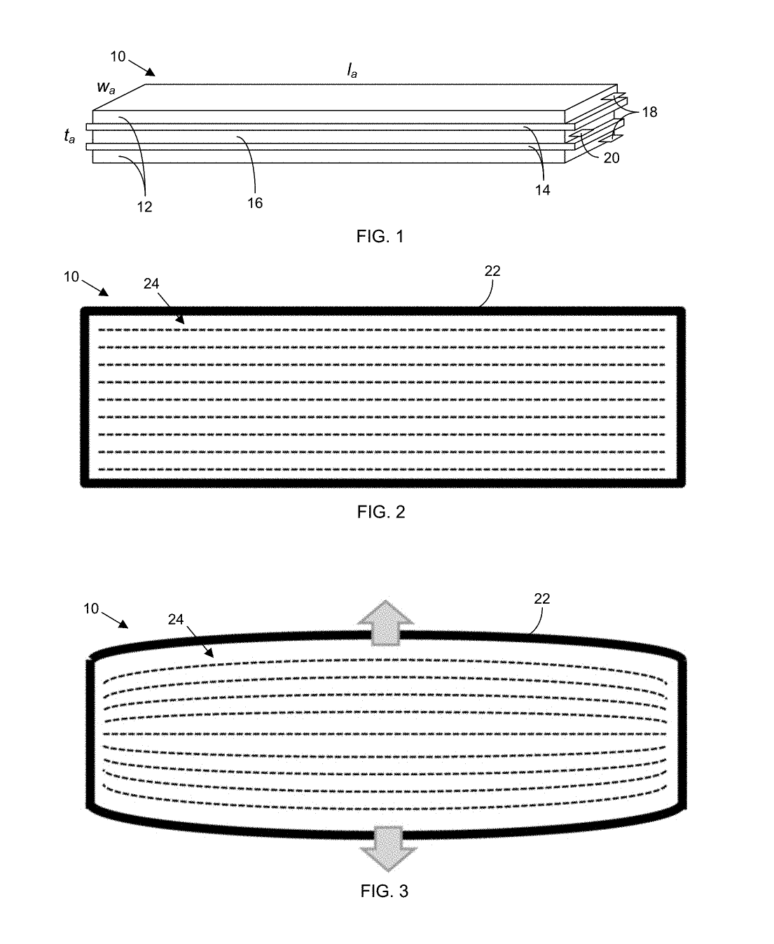

As used herein, a thickness, tₐ, of the electrode assembly is parallel to a thickness, tₐ (vertical), dimension of the anode 16 and cathodes 12 in FIG. 1. The electrode-assembly thickness, tₐ, is approximately equal to an average thickness, hₑ, of the stack of electrodes 12 and 16 that makes up the prismatic electrode assembly. As used herein, a width, wₐ, of the electrode assembly corresponds to a maximum dimension of the electrode assembly in a direction perpendicular to the thickness, tₐ. The aspect ratio is defined as a ratio of the width to the thickness of the electrode assembly (wₐ/tₐ). In accordance with embodiments of the present invention, the aspect ratio, wₐ/tₐ, is <1.

As used herein, the “case” of a cell is used to refer to an external shell on a prismatic or cylindrical cell. In a typical cell having a case, the case may comprise aluminum metal having a thickness ranging from 100-300 μm. In the present system, this case should be contrasted with a “soft pouch”, which may comprise a laminate of polymer layers and aluminum (Al) foil, wherein the Al thickness ranges typically from 3 to 30 μm. Thus, the mechanical forces required to produce a given change in the dimensions of a soft pouch are far smaller than those required to produce a corresponding change in the dimensions of a case. For example, typical Al has a modulus of 68.9 GPa, so the tensile force required to produce a 0.1% tensile strain in a 200-μm-thick case is 14 N/mm (per mm of length of case), while the force required to produce a 0.1% extension in a 6-μm-thick foil is 0.41 N/mm. Note that when subjected to beam-bending forces, the difference between the pouch and case is even more dramatic since the displacement now depends on the square of the thickness.

Some embodiments of the electrochemical battery cell include a design configuration having a metal anode in a non-aqueous electrolyte. The design is applicable to, e.g., Mg, Li, or other high-capacity metal anodes for use in high-energy-density batteries. As used herein, “high energy density” means >600 Wh/l. The advantages of the battery cell design accrue to metal-anode cells (e.g., Li and Mg) as well as to Li-ion cells.

In designing a cell for inclusion in a device, it is frequently a goal to make the cell as thin and flat as possible. A thin cell permits more efficient incorporation of the battery into the electronic package. This low aspect ratio also permits incorporation of a battery into a very-thin electronics device. Minimizing the thickness of the overall device has become an important goal in design consumer electronics and similar devices.

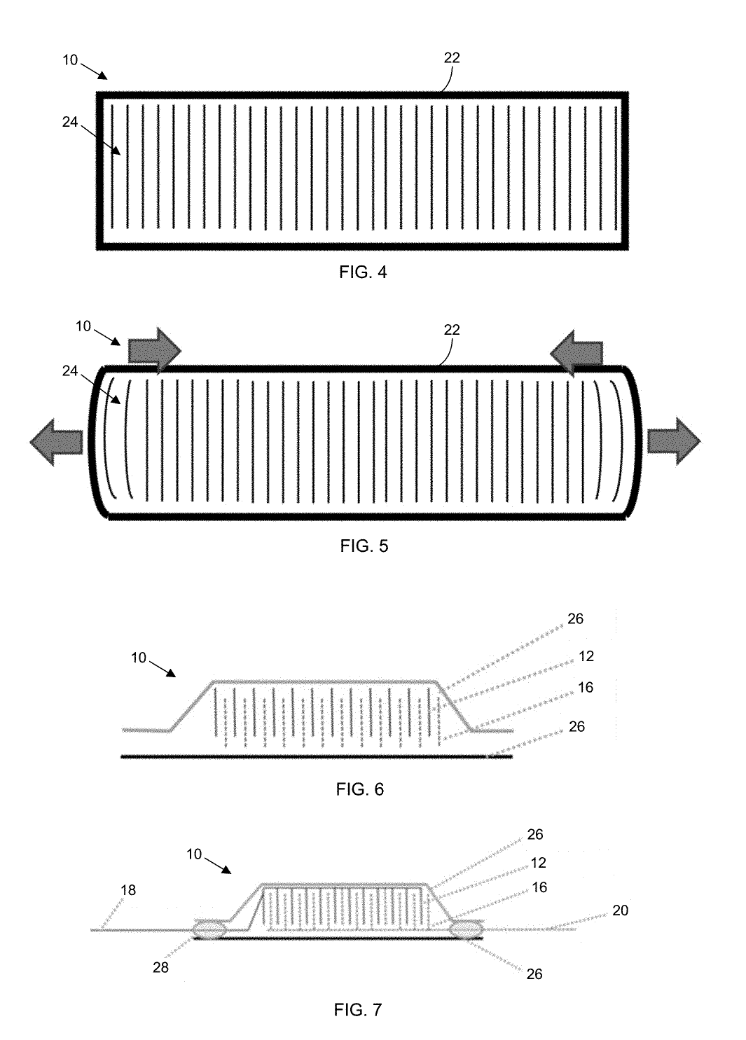

Referring to FIGS. 2-5, the schematic illustrations show how expansion of electrode stacks 24 due to stack “swelling” produces different forces depending on the stack configuration. Within each stack 24, layers are similarly oriented parallel to a common set of orthogonal axes such that respective lengths and widths of the respective layers define planes that are parallel to each other. “Swelling”, as used herein, involves curvature of the electrodes 12 and 16 and/or case 22 and is equal to the percentage of dimensional expansion of the entire cell 10 normal to the stack 24 (i.e., normal to a plane of an electrode 12/16—in FIGS. 2 and 3, the planes extend horizontally along each layer and orthogonally into the page), measured between comparable states-of-charge (i.e., fully discharged at cycle-1 versus fully discharged at cycle-n, or the same for fully charged). Forces exerting stack pressure in the embodiment of FIGS. 2 and 3 are thus limited by the yield-point strength of the electrodes 12 and 16 or case 22 in a beam-bending configuration. In the embodiment of FIGS. 4 and 5, swelling (expansion of the stack 24) now involves extension of the electrodes 12 and 16 or case 22; and forces exerting stack pressure are now limited by the yield-point strength of the electrodes 12 and 16 or case 22 in uniaxial extension.

“Breathing” as used herein, is equal to the percentage of dimensional expansion of the entire cell 10 normal to the stack 24 (i.e., normal to a plane of an electrode 12/16), measured between opposite states of charge on the same cycle (i.e., fully discharged at cycle-n vs fully charged at cycle-n+1). Breathing may occur due to a change in layer thickness between the discharged and charged states, including but not limited to thickness increase due to the plating of a metal layer, thickness increase or decrease due to intercalation, and thickness increase or decrease due to changes in mechanical pressure. Swelling may arise from a range of mechanisms including but not limited to the following causes: layer expansion due to reaction between the electrolyte and anode or cathode during cycling, including formation of the solid electrolyte interphase (SEI), at both anode and cathode; changes in the density of the materials at a fixed state of charge, including but not limited to the increase in porosity of materials, such as the increase in surface area of a plated anode with progressive cycling; and continuing uptake of electrolyte into materials, especially polymers, that form the electrodes or separator.

The restoring forces arising from this swelling are a consequence of the distortion this swelling produces in the cell elements. As the layer spacing increases, cell elements that are oriented with their longest dimensions parallel to the thickness of the layers have to increase along their longest dimensions, while cell elements that are oriented with their longest dimension perpendicular to the thickness of the layers do not have to increase along their longest dimension. In a conventional planar-configuration cell, this generally leads to a cell 10 in which the layers are bowed, as illustrated in FIGS. 2 and 3. The restoring forces opposing the breathing and swelling of the cell 10 are the tension in the cell-case elements perpendicular to the layers, plus beam-bending forces in the cell-case elements perpendicular to the thickness of the layers. Thus, the compressive stack pressure acting on the layers depends primarily on the number and separation of the cell elements with their longest dimensions parallel to the thickness of the layers. The smaller the separation between cell elements that have their longest dimensions parallel to the thickness of the layers, and the greater the tensile modulus of these elements, the larger the stack pressure exerted during breathing and swelling (e.g., having stack pressure of greater than 0.5 MPa, greater than 1.0 MPa, or even greater than 2.0 MPa).

In particular embodiments, the layers are configured at right angles to the conventional arrangement, such that the length and width (i.e., the greatest dimensions) of each layer are arranged perpendicular to the greatest dimension (i.e., the thickness) of the stack 24. The largest and most robust elements of the cell casing 22 are now placed into tension by swelling and breathing. The spacing between tensile-strained cell components (parallel to the thickness of the layers) is minimized. Similarly, the elements subjected to beam-bending forces are now minimized in length. It can be seen based on the figures that the difference between the stack pressures that can be exerted in FIGS. 3 and 5 is very large. In addition, it is also clear that the difference becomes more important as the overall cell 10 becomes thinner.

In a spiral-wound cell 10, where the electrode winding may be produced by winding electrodes 12 and 16 and separators 14 on a winding mandrel, leaving an axial cavity at the center of the winding, cell elements parallel to (or coaxial with) the layers (e.g., extending around the outer radius of the spiral) have to increase in length to accommodate an increase in radius of the cell 10 (i.e., increase in layer spacing). In this configuration, therefore, the normal metal foils used as current collectors serve to exert stack pressure. In a conventional soft-pouch wound cell 10, the cell 10 has an aspect-ratio greater than one [i.e., a cylinder radius (or dimension perpendicular to the layer stack) that is smaller than the direction parallel to the layers of the stack 24. However, in the apparatus described herein, this ratio is inverted and the cell 10 can be designed with the minimal possible thickness in order to allow for a very-thin cell design with very-high stack pressure.

In the art, for certain electrochemical systems, high stack pressure is known to be desirable. For example, secondary lithium metal cells are reported to have superior cycling characteristics when the stack pressure is high. Canadian Patent No. 1,190,279 describes how the cycling of a lithium-metal anode is affected by stack pressure and explicitly specifies that “means for applying stack pressure” is required external to the cell. However, clamps and similar means for applying stack pressure consume considerable volume, decreasing the overall energy-density of a cell provided with stack pressure. Similarly, Hirai, et al., “Influence of Electrolyte on Lithium Cycling Efficiency with Pressurized Electrode Stack,” 141 J. Electrochem. Soc., 611-614 (March 1994) discloses the importance of stack pressure in achieving optimal cycling in a lithium-metal anode cell. Again, this paper discloses stack pressure applied by external means. A desirable outcome would be a cell design that achieves stack pressure without such external means.

Likewise, in the art, it is known that it is desirable to minimize the dimensional change of a cell over the course of cycling because of undesirable mechanical effects arising due to this dimensional change, including strain, stress fractures, fatigue, and stress cracking of materials components in the cell. Likewise, it is known in the art that applying a mechanical compressive force opposing this dimensional change through positive stack pressure can serve to minimize the dimensional change. The application of stack pressure to a cell 10, however, involves an additional mechanical component external to the cell 10.

Likewise, in the art, it is known that stack pressure may be achieved in a large cell through a wound-cell construction, such as in an 18650 cell. In this cylindrical construction, it is thought that the hard case of the 18650 cell provides the compressive force. The minimum dimension of an 18650 cell, however, is 18 mm (diameter), which is too large for applications that require the use of a thin cell (e.g., <10 mm) to power a device.

Therefore, embodiments described herein can provide such a stack pressure and reduce dimensional changes (via breathing) in a cell having small dimensions and without being constructed only of rigid components.

Embodiments that include a metal-anode spiral-wound cell allow one to reduce the overhead that arises from the overlap mentioned in the Background. By overlapping a bare metal anode 32 at the end of the cell, one can significantly reduce the volume of the battery [e.g., wrapping a 10-micrometer (μm) metal foil rather than a 150-μm active anode]. Furthermore, this portion of the cell 10 actually cycles some capacity, thereby contributing to the performance of the battery.

An electrical feed-through may extend through at least one seal 28 of the pouch 26. This configuration is simpler to manufacture than a conventional welding of a connector to a metal can housing. This configuration can also be cheaper to produce and permits lower cell thickness (wherein the thickness of the cell is the smallest dimension of the cell).

Low-aspect-ratio battery form factors in accordance with embodiments of the invention may have one of the following configurations:
(i) a low-aspect-ratio prismatic cell (with electrode 12 and 16 and separator 14 layers stacked perpendicular to the thin dimension of the cell 10);
(ii) a wound prismatic cell (with layers wound around an axis parallel to the smallest cell dimension); or
(iii) a flat cylindrical button cell disposed in a pouch 26.

Referring to the embodiments of FIGS. 6, 7 and 10, an electrode assembly may include a plurality of stacked electrodes (i.e., stacked anode 16 and cathode 12 pairs). The number of electrode pairs may range from 1 to 10, from 1 to 20, from 1 to 100, or from 1 to 1,000. Each anode 16 and each cathode 12 may be sized such that the total area multiplied by the capacity per unit area matches the total capacity desired from the designed device. For example, each electrode 12 and 16 may have a width, wₑ, selected from a range of 5 mm to 100 mm; a height (length), lₑ, selected from a range of 10 mm to 50 mm; and a thickness, tₑ, selected from a range of 10 μm to 300 μm. A separator may be disposed in the intervening spaces between each anode 16 and cathode 12 to prevent shorting. The separator 14 may have a composition selected from a porous electrically insulating material including but not limited to porous polyethylene (PE), polypropylene (PP), porous ceramic coating, or a combination, such as ceramic-coated porous polyethylene.

As used herein, a thickness, tₐ, of the electrode assembly corresponds to a smallest dimension of the anode 16 and cathode 12 pair. Furthermore, the thickness of the stack is the cumulative thickness of all anode and cathode pairs comprising the electrode assembly of the cell. The electrode-assembly thickness, tₐ, is approximately equal to an average composite length, lₑ, of the electrodes 12 and 16 that make up the electrode assembly. As used herein, a width, wₐ, of the electrode assembly corresponds to a maximum dimension of the electrode assembly in a direction perpendicular to the electrode-assembly thickness, tₐ). The aspect ratio is defined as a ratio of the width to the thickness (wₐ/tₐ) of the electrode assembly. In accordance with embodiments described herein, the aspect ratio wₐ/tₐ is less than 1.

Each anode 16 and/or each cathode 12 may be a metal, an alloy, or an intermetallic compound. For example, the anode 16 may include an electrochemically active metal including a Group I element and/or a Group II element (e.g., Li or Mg). At least one of the anode 16 or cathode 12 may include a material configured to undergo an insertion reaction, an intercalation, a disproportionation, a conversion reaction, or a combination thereof. For example, the anode 16 may include a material configured to undergo an intercalation reaction with the electrochemically active species, such as an intercalation of graphite with lithium. Alternatively, the anode 16 may include a material configured to undergo a conversion reaction, such as a conversion of silicon to silicon-lithium. Alternatively, the anode 16 may be an electrochemically inert current collector configured so that the electrochemically active anode species plates in metal form onto the current collector. An example of such a system includes magnesium or lithium plating onto an inert copper current collector.

The cathode 12 may include a material configured to undergo an intercalation reaction, such as Mg intercalation. Cathode compositions permitting Mg intercalation include but are not limited to V₂O₅, Mn₂O₄, and a range of organic compounds, such as dimethoxy benzoquinone (“DMBQ”). Intercalation cathodes for other metals include, but are not limited to, widely known lithium intercalation compounds, such as lithium cobalt oxide (“LCO”), lithium nickel manganese cobalt oxide (“NMC”), and lithium manganese oxide (“LMO”). Alternatively or additionally, the cathode may include a material configured to undergo a conversion reaction, such as FeF₃⇔LiFeF₃.

In particular embodiments, the electrolyte can be, e.g., LiAsF₆-2-methyltetrahydrofuran (2MeTHF)/methyl formate (MF), LiAsF₆-2MeTHF/tetrahydrofuran (THF), LiAsF₆-ethylene carbonate (EC)/propylene carbonate (PC), or LiAsF₆-EC/2MeTHF.

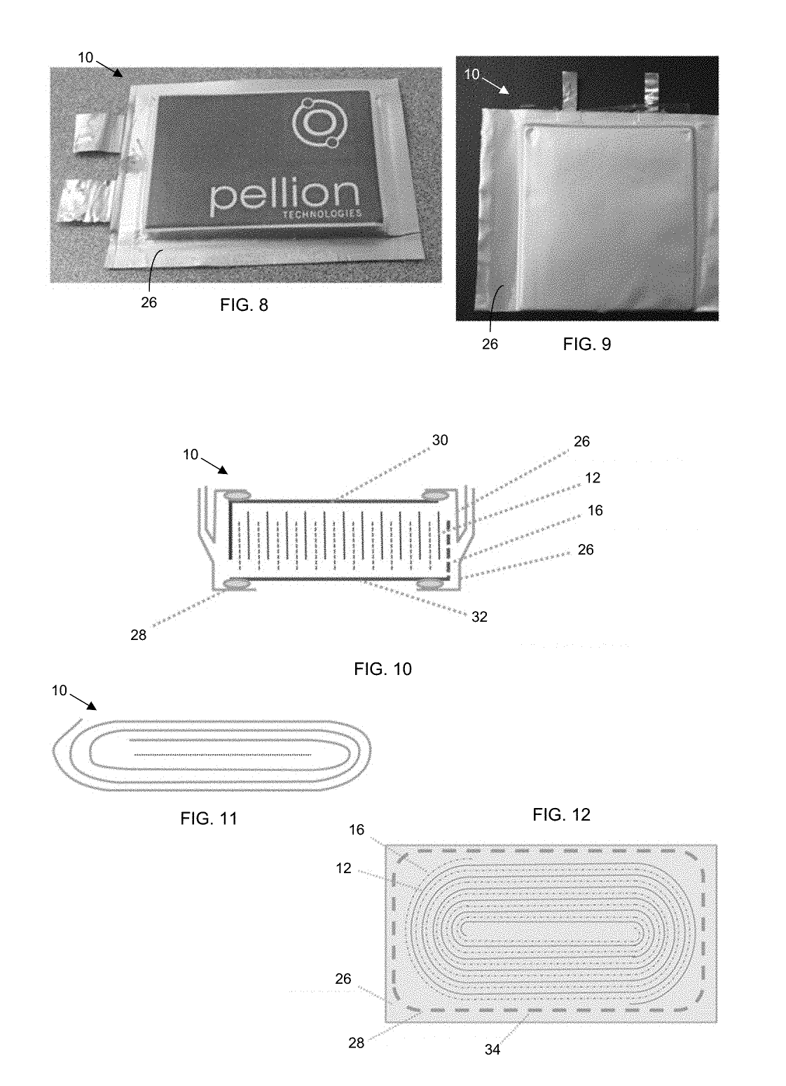

Referring also to FIGS. 8 and 9, a housing, including an electrically insulating soft (flexible) pouch 26, encloses the electrode assembly. In a conventional pouch cell, the pouch cell layers are stacked parallel to the external cell dimension “thickness.” In various embodiments, the cell construction may be similar to that of a conventional cell, except layers are oriented such that their thicknesses are orthogonal to the external cell dimension “thickness”; and the battery layers are stacked therein in a horizontal (rather than vertical) arrangement (in the orientation shown in FIGS. 6, 7, and 10), wherein the layers are oriented such that their thicknesses are orthogonal to the external cell dimension “thickness” (i.e., to the smallest dimension of the overall cell 10).

Referring to FIG. 7, a pouch 26 suitable for use with embodiments of the invention includes insulating pouch material wrapped around a stack 24 with electrode connections 18 and 20 (also referred to herein as “electrical connectors” or “conducting tabs”) emerging at the seals 28 between the two halves of the pouch 26. Both the anode and cathode tabs 20 and 18 may emerge from the seal 28.

The pouch 26 may be sealed by hot-pressing two halves of a pouch cell together, creating a molten layer that flows and joins the two halves. The conducting tabs 18 and 20 may be wrapped in an additional layer of polymer at the point where they pass through the seal 28 so that there is excess polymer at this point that flows during the hot-melt procedure. The “soft pouch” 26 may be made from laminated materials (e.g., polymer/aluminum/polymer layers). Suitable pouch materials and sealing polymers are well-known and commercially available. For example, the composition of the pouch 26 may be an aluminum laminate, manufactured by Showa Denko, or Dai Nippon Printing, both based in Japan. In particular embodiments, the soft pouch 26 can have a thickness of about 50 to 200 μm and a drawing (stretching or forming) depth up to 8.0 mm.

Additionally, in particular embodiments, a multi-layer pouch 26 can include a nylon layer, an aluminum foil layer, and a cast polypropylene (CPP) layer. The pouch 26 can be multi-layered with a customer-specified layer thickness, and may include a polyethylene terephthalate (PET) layer. A suitable sealing polymer is polytetrafluoroethylene (PTFE). Such a construction leads to a pouch 26 that is flexible [i.e., has a flexural rigidity similar to (e.g., of the same order of magnitude as) the above-described existing laminate foils used for packaging], as opposed to the prior use of a rigid can with two sides that are separated by an insulating ring. Without being limited to a particular embodiment, “soft pouch” can be defined as an enclosure for an electrode assembly wherein the walls of the enclosure are impermeable to gas and liquid, and provide high electrical resistivity and chemical inertness while also allowing for a high degree of elastic and plastic deformation.

Referring to FIG. 10, in some embodiments, the housing may include one or more conductive plates 30 and 32 integrated with the pouch 26. In such an embodiment, the conducting material may comprise materials similar to those used for the current collectors—for example, aluminum, copper, or stainless steel. Alternatively the conducting material may comprise any conductor chosen so as to be compatible with the electrolyte. The conductive plate or plates 30 and 32 may form means for electrical connection to the electrodes 12 and 16 inside the cell. The conductive plate or plates 30 and 32 may be flexible (e.g., can be in the form of a thin aluminum foil), or the conductive plates may be rigid so as to provide mechanical support to the cell assembly.

Referring to FIGS. 11-13 (where electrode-assembly thickness, tₐ, is measured across the cell along an axis through the center of the cell and orthogonal to the local orientation of the length and width of the electrodes in the plane of the drawing along the greatest dimension in this plane and where the width, wₐ, is measured normal to the plane of the drawing) a wound prismatic battery cell 10 in accordance with embodiments of the apparatus has an aspect ratio (wₐ/tₐ)<1. The wound prismatic cell 10 may have a “racetrack” arrangement of layers when viewed from above, as illustrated in FIG. 11. Conventionally wound prismatic batteries have an analogous arrangement of layers when viewed from the side. Thus, the configuration of FIG. 11 would be a side view for a conventional wound prismatic but is a top view of embodiments described herein.

In particular, referring to the top view of FIG. 12 and the cross-sectional view of FIG. 6, a wound prismatic cell 10 may include a first electrode (e.g., an anode 16), and a second electrode (e.g., a cathode 12), with a separator 14 disposed between the first and second electrodes 16 and 12, wound in an oval “racetrack” shape. The separator 14 may comprise polypropylene, polyethylene, or other electrically insulating polymer or may include a coating of a ceramic material, such as alumina or other electrically insulating material; or the separator 14 may comprise a combination of a plurality of these components. The separator 14 may be porous so as to permit permeation of a liquid electrolyte through the material, wherein the liquid electrolyte is contained in the cell 10 and allows transport of electrochemically active species from the anode 16 to the cathode 12. The number of windings may range from one to 1,000 and may typically be in the range of 10-500 and, in particular embodiments, in the range of 50-200.

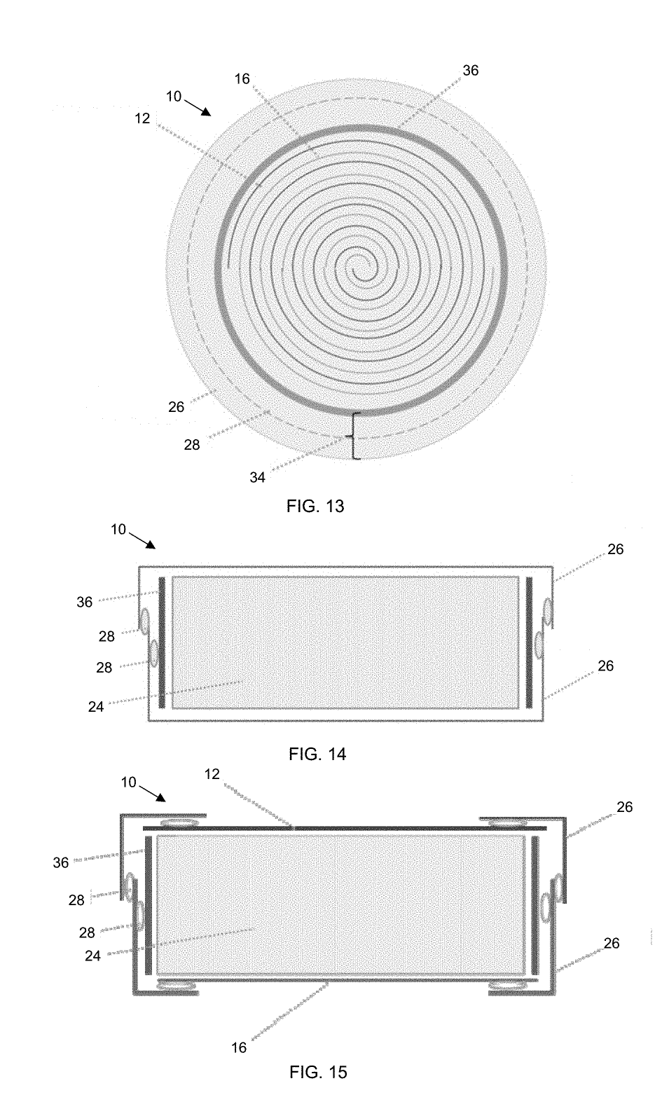

Referring to FIGS. 13 and 6, a flat cylindrical button cell 10 may have a spiral-wound anode 16 and cathode 12 pair. A top view of the configuration is shown in FIG. 13, and a cross-sectional view is provided in FIG. 6. A separator 14 may be disposed between the anode 16 and the cathode 12 to prevent shorting and may have the same composition and characteristics as described in the preceding paragraph.

In various embodiments of the invention, non-aqueous electrolyte may fill the cell 10 and be in contact with the electrode assembly. The non-aqueous fluid electrolyte may include at least one active cation, such as Mg⁺² ion, Al⁺² ion, Ca⁺² ion, Sr⁺² ion, Ba⁺² ion, Li⁺ ion, Na⁺ ion, K⁺ ion, Rb⁺ ion, Cs⁺ ion, and onium ions. Alternatively, the non-aqueous fluid electrolyte may include a symmetric or asymmetric aluminum-based or boron-based anion.

The non-aqueous fluid electrolyte may include a salt or a combination of salts in a concentration in the range of 0.5 M to its saturated concentration.

In a further embodiment, the non-aqueous fluid electrolyte may include an anion, such as hexafluorophosphate, bis(triflurosulfonyl)imide, fluorosulfonylimide, bis(oxalato)aluminate, difluoro-oxalato aluminate, difluoro-oxalato borate, or bis(oxalato)borate, bis(malonato)borate, bis(perfluoropinacolato)borate, tetrafluoroborate, triborate (B₃O₇⁵⁻), tetraborate (B₄O₉⁶⁻), metaborate (BO₂⁻), and combinations thereof.

The non-aqueous fluid electrolyte may include LiPF₆, Mg[BF₂(C₂O₄)]₂, Mg[B(C₂O₄)₂]₂, LiBF₂(C₂O₄), LiB(C₂O₄)₂, NaBF₂(C₂O₄), and NaB(C₂O₄)₂, or combinations thereof.

Referring to FIGS. 14 and 15, in some embodiments, a pouch 26 with no seam may be used in conjunction with a hard sleeve 36 to reduce dead area 34. Instead of conducting tabs 18 and 20 extending through a seam, a top contact and/or a bottom contact (electrodes 12 and 16) may be exposed.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments of the invention, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention. In method claims (or where methods are elsewhere recited), where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. An electrochemical cell, comprising:
an electrode assembly comprising at least one pair of a wound or stacked anode and cathode, wherein the electrode assembly and each anode and cathode respectfully have a thickness, width and length measured parallel to a common set of orthogonal axes, wherein (i) the thickness represents the smallest dimension of each anode and cathode but represents the greatest dimension of the full electrode assembly, (ii) the width represents a maximum dimension perpendicular to the thickness, and (iii) an aspect ratio of the width to the thickness of the electrode assembly is less than 1; and
a housing comprising an insulating soft flexible pouch enclosing the electrode assembly.

2. The electrochemical cell of claim 1, wherein the pouch comprises a seal, the electrochemical cell further comprising an electrical connector in electrical communication with the electrode assembly and extending through the seal.

3. The electrochemical cell of claim 2, wherein the electrical connector comprises a conducting tab.

4. The electrochemical cell of claim 1, wherein the housing further comprises a conducting plate integrated with the pouch.

5. The electrochemical cell of claim 1, further comprising a non-aqueous electrolyte in contact with the electrode assembly.

6. The electrochemical cell of claim 1, wherein the pouch is a laminate comprising an aluminum foil and at least two polymer layers.

7. The electrochemical cell of claim 1, wherein the anode comprises an electrochemically active metal selected from the group consisting of a Group I element and a Group II element.

8. The electrochemical cell of claim 7, wherein the electrochemically active metal is selected from the group consisting of Li, Na, and Mg.

9. The electrochemical cell of claim 7, wherein at least a portion of the electrochemically active metal is electrodeposited on the anode during charge and electrodissolved during discharge of the electrochemical cell.

10. The electrochemical cell of claim 1, wherein the cathode comprises a material selected from the group configured to undergo an insertion reaction, an intercalation, a disproportionation, a conversion reaction, and combination of both reactions.

11. The electrochemical cell of claim 1, wherein the cathode comprises an organic compound.

12. The electrochemical cell of claim 1, wherein the cathode comprises a material selected from lithium cobalt oxide (“LCO”), lithium nickel manganese cobalt oxide (“NMC”), and lithium manganese oxide (“LMO”).

13. The electrochemical cell of claim 1, wherein at least a portion of the cathode composition is deposited on the anode during cycling of the electrochemical cell.

14. The electrochemical cell of claim 1, wherein the electrode assembly has an energy density of greater than 600 Wh/l.

15. The electrochemical cell of claim 1, wherein the electrode assembly undergoes greater than five percent expansion and contraction within one charge and discharge cycle.

16. The electrochemical cell of claim 1, wherein the housing has a length, width and thickness, wherein the thickness is the smallest dimension of the housing, and wherein the thickness of the electrode assembly is parallel to at least one of the length, the width, and a combination thereof of the housing.

17. The electrochemical cell of claim 1, wherein the housing has a thickness that represents its smallest dimension, and wherein the thickness of the electrode assembly is orthogonal to the thickness of the housing.

18. The electrochemical cell of claim 1, further comprising a hard sleeve situated between the electrode assembly and the pouch.

19. A battery-powered electronic device, comprising:
a rechargeable battery comprising an electrode assembly comprising at least one pair of a wound or stacked anode and cathode, wherein the electrode assembly and each anode and cathode have a thickness, width and length measured parallel to a common set of orthogonal axes, wherein (i) the thickness represents the smallest dimension of each anode and cathode but represents the greatest dimension of the full electrode assembly, (ii) the width represents a maximum dimension perpendicular to the thickness, and (iii) an aspect ratio of the width to the thickness of the electrode assembly is less than 1; and
a housing comprising an insulating soft flexible pouch enclosing the electrode assembly.

20. The battery-powered electronic device of claim 19, wherein the rechargeable battery has a thickness less than 10 mm.
